(19) United States
(12) Patent Application Publication
(10) Pub. No.: US 2011/0025691 A1
(43) Pub. Date: Feb. 3, 2011

(54) METHOD AND DEVICE FOR DISPLAYING COMPUTED-TOMOGRAPHY EXAMINATION DATA FROM AN EXAMINATION OBJECT

(75) Inventor: Eckhard Hempel, Furth (DE)

Correspondence Address: HARNESS, DICKEY & PIERCE, P.L.C., P.O.BOX 8910, RESTON, VA, 20195, US

(73) Assignee: Siemens Aktiengesellschaft, Munich (DE)

(21) Appl. No.: 12/841,342

(22) Filed: Jul. 22, 2010

(30) Foreign Application Priority Data
Jul. 30, 2009 (DE) 10 2009 035 286.4

(51) Int. Cl. G06T 17/00

(52) U.S. Cl. 345/424

(57) ABSTRACT

A method and a device are disclosed for displaying computed-tomography examination data from an examination object. In at least one embodiment, there firstly is of the examination object at least one first CT image data record with pixel or voxel values, which were reconstructed on the basis of quantitatively measured absorption data of X-ray beams passing through the examination object; and there secondly is at least one second CT image data record with pixel or voxel values, which were reconstructed on the basis of quantitatively determined phase shifts of X-ray beams passing through the examination object. In at least one embodiment, the at least one first CT image data record and the at least one second CT image data record are combined together pixel-by-pixel or voxel-by-voxel using a nonlinear function, and the combined values resulting therefrom are displayed visually as CT results image data record.

### PRIORITY STATEMENT

The present application hereby claims priority under 35 U.S.C. §119 on German patent application number DE 10 2009 035 286.4 filed Jul. 30, 2009, the entire contents of which are hereby incorporated herein by reference.

### FIELD

At least one embodiment of the invention generally relates to a method and/or a device for displaying computed-tomography examination data from an examination object, wherein there firstly is of the examination object at least one first CT image data record with pixel or voxel values, which were reconstructed on the basis of quantitatively measured absorption data of X-ray beams passing through the examination object, and there secondly is at least one second CT image data record with pixel or voxel values, which were reconstructed on the basis of quantitatively determined phase shifts of X-ray beams passing through the examination object.

### BACKGROUND

By way of example, the document DE 10 2007 036 559 A1 discloses the superposition of an absorption X-ray display onto a phase-contrast image display for an improved display of metabolic markers. Herein, this should also achieve improved anatomical orientation for the observer.

Furthermore, the field of dual-energy computed-tomography illustrations has disclosed the superposition in a nonlinear fashion of CT image data records recorded at different X-ray energies within the scope of absorption measurements, and so certain structures in the image became clearer depending on the selected superposition criteria. If CT absorption illustrations are observed, it becomes clear that these illustrations are particularly suitable for distinguishing certain structures in the human body, for example bone structures or blood vessels filled with contrast agent, and the linking of said blood vessels. However, at the same time there is the problem that tissue structures with similar densities can only be visualized badly by absorption recordings.

By contrast, if CT phase-contrast recordings are observed, it can be seen that this phase-contrast imaging allows the best-possible resolution of these structures, which are poorly resolved in CT absorption recordings. By way of example, this holds true for different tissue types that although having a very similar density, they can easily be distinguished by different refractive indices.

### SUMMARY

In at least one embodiment of the invention, a method and a device are disclosed that, by combining a CT image data record obtained from absorption data and a CT image data record obtained on the basis of phase shifts of X-ray beams, allow the combination of the advantages of both methods, and so a optimum display of an examination object is possible.

The inventor, in at least one embodiment, has recognized that it is possible to form a combination of a CT absorption image data record and a CT phase-contrast image data record with the aid of a nonlinear function such that in a results image created therefrom the positively identifiable structure details of the respective image data record are maintained in each case, while image portions with little structure can be suppressed to at least a great extent. In particular, transitions between various tissue types and inhomogeneities within a tissue type can be imaged with more contrast in this fashion. Thus, the advantage consists of the fact that the combination of both measurement methods and visual accentuation of the respectively present detailed information overall allows an improved assessment of the image data.

Accordingly, in at least one embodiment the inventor proposes a method for displaying computed-tomography examination data from an examination object, wherein there firstly is of the examination object at least one first CT image data record with pixel or voxel values, which were reconstructed on the basis of quantitatively measured absorption data of X-ray beams passing through the examination object, and there secondly is at least one second CT image data record with pixel or voxel values, which were reconstructed on the basis of quantitatively determined phase shifts of X-ray beams passing through the examination object, wherein, according to at least one embodiment of the invention, the at least one first CT image data record and the at least one second CT image data record are combined together pixel-by-pixel or voxel-by-voxel using a nonlinear function, and the combined values resulting therefrom are displayed visually as CT results image data record.

This nonlinear combination of CT absorption image data records and CT phase-contrast image data records now allow the combination of the respective positive properties of both imaging methods such that an overall image is generated, which in total possesses optimal richness of detail. If there were a linear combination of the image data with an arbitrary linear weighting, this could merely achieve a compromise between the individual detailed illustrations of the two items of image data, but an optimum display would not be possible.

It is advantageous in the method of at least one embodiment if prior to the nonlinear combination of the CT image data records at least one of the CT image data records is normalized to a range of image values equal to the other CT image data record. Thus, this can ensure that the image impression in the respective image regions in which the details can be identified in an optimum fashion are matched to one another, and so an overall homogeneous image impression can be created.

A particular embodiment of the method according to the invention proposes that in one of the CT image data records a portion of the CT image data record is segmented according to prescribed criteria and segmented portions are combined with a different weighting than non-segmented portions. By way of example, this allows regions with optimum structures in a conventional CT absorption image data record, such as the display of bones, to be segmented and to be reproduced without change, whereas soft tissue regions are mainly superposed by the illustration from a parallel phase-contrast image. Conversely, it goes without saying that it is also possible to initially observe the CT phase-contrast image and to carry out a segmentation there of optimally imaged portions and to display the less detailed portions in an improved fashion by mainly superposing the CT absorption image data record. By way of example, for this, there is the option of using thresholds in respect of the CT numbers in the first CT image data record as criterion for the segmentation.

According to a similar variant of the method according to at least one embodiment of the invention, the inventor proposes the use of a sigmoid curve as a nonlinear function for combining the CT image data records, which sigmoid curve determines the complementary weighting of the first and second CT image data records as a function of image values of at least one of the CT image data records. Use can also be made in this case of, for example, the CT value of a CT absorption image data record; however, sharp boundaries, like in the generation of segmented portions, are then not generated here but rather flowing transitions in the weighting of the image data records, and so overall this results in a homogeneous impression of the results image data record.

Moreover, particularly when a sigmoid weighting function is used, there is the option of the nonlinear function having at least one manipulated variable that can be changed by an observer and an image result is displayed directly after changing a manipulated variable, which image result can be evaluated by the observer. This measure allows the observer to change continuously this at least one changeable manipulated variable and, according to the resulting image impression, to find the optimum combination of the changeable manipulated variables or the single changeable manipulated variable according to the created image impression.

Additionally, in at least one embodiment the inventor proposes two different sigmoid functions in respect of these changeable manipulated variables, which sigmoid functions can be used to weight the CT image data records, wherein these manipulated variables have the following form:

Firstly:

$$μ = \frac{1}{1 + {e}^{\frac{{I}_{A} - λ}{ϖ}}} ,$$

wherein I_{A} corresponds to the image value of the pixel or the voxel in the first CT image data record,
λ corresponds to a variable bringing about a parallel displacement of the function μ, and
ω̅ corresponds to a variable bringing about a stretching of the function μ,
wherein the image values of the CT results image I_{E} are calculated by:

I_{E}=(1−μ)*I_{A}+μ*I_{Ph},

with I_{Ph} being the image values from the second CT image data record.

Secondly, the function can also be:

$$μ = \frac{1}{1 + {e}^{\frac{{I}_{Ph} - λ}{ϖ}}} ,$$

wherein I_{Ph} corresponds to the image value of the pixel or the voxel in the second CT image data record,
λ corresponds to a variable bringing about a parallel displacement of the function μ, and
ω̅ corresponds to a variable bringing about a stretching of the function μ,
wherein the image values of the CT results image I_{E} are calculated by:

I_{E}=(1−μ)*I_{A}+μ*I_{Ph},

with I_{A} being the image values from the first CT image data record.

Thus, according to the aforementioned variants, this on the one hand opens the possibility of devising this nonlinear function for combining the image data records to be spatially dependent; on the other hand, it is also possible for this function to be devised as image-value dependent. In respect of the image-value dependence of the nonlinear function, it is also possible not only to consider the image value of the respective voxel, but also the image values in the surroundings such that this results in a combination of image-value dependence and spatial dependence.

In addition to the aforementioned method according to at least one embodiment of the invention, the scope of the invention also comprises a CT system for generating computed-tomography CT image data records on the basis of quantitatively measured absorption values and phase-shift values when X-ray beams pass through an examination object, more particularly a patient, which CT system has a control and computational unit with a program storage medium, wherein program code is stored in the program storage medium and executes the method according to at least one embodiment of the invention when the computational unit is operational.

Something corresponding likewise holds true for a computational unit, which does not necessarily have to be installed in direct combination with a CT system, but merely has to be provided with corresponding CT image data records from absorption measurements and phase-contrast measurements.

### BRIEF DESCRIPTION OF THE DRAWINGS

Hereinbelow, embodiments of the invention will be described in more detail with the aid of the figures, with only the features required for the understanding of the invention being illustrated. The following reference signs are used: 1: CT system; 4: X-ray tube; 5: detector system; 6: gantry housing; 8: patient couch; 9: system axis; 10: control and computational unit; 51-59: method steps; 61-68: method steps; I_{A}: CT absorption image data record; I_{Ph}: CT phase-contrast image data record; I_{E}: Results image; K: bones; P: patient; Prg₁-Prgₙ: computer programs; [symbol] _{A}: reconstruction of the absorption data; [symbol] _{Ph}: reconstruction of the phase-contrast data; S: segmentation of the absorption data; S⁻¹: inverted segmentation of the absorption data for the phase-contrast image data; W: soft-tissue structure.

In detail:

FIG. 1 shows a CT system for absorption and phase-contrast imaging,

FIG. 2 shows a display of a slice image from CT image data of a head on the basis of X-ray absorption image data,

FIG. 3 shows a display of a slice image from CT image data of a head on the basis of X-ray phase-contrast image data,

FIG. 4 shows a combination of the displays from FIGS. 2 and 3,

FIG. 5 shows a flowchart of a method for combining CT absorption and CT phase-contrast image data records and

FIG. 6 shows a flowchart of a method for combining CT absorption and CT phase-contrast image data records by way of an image-value-dependent sigmoid function.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

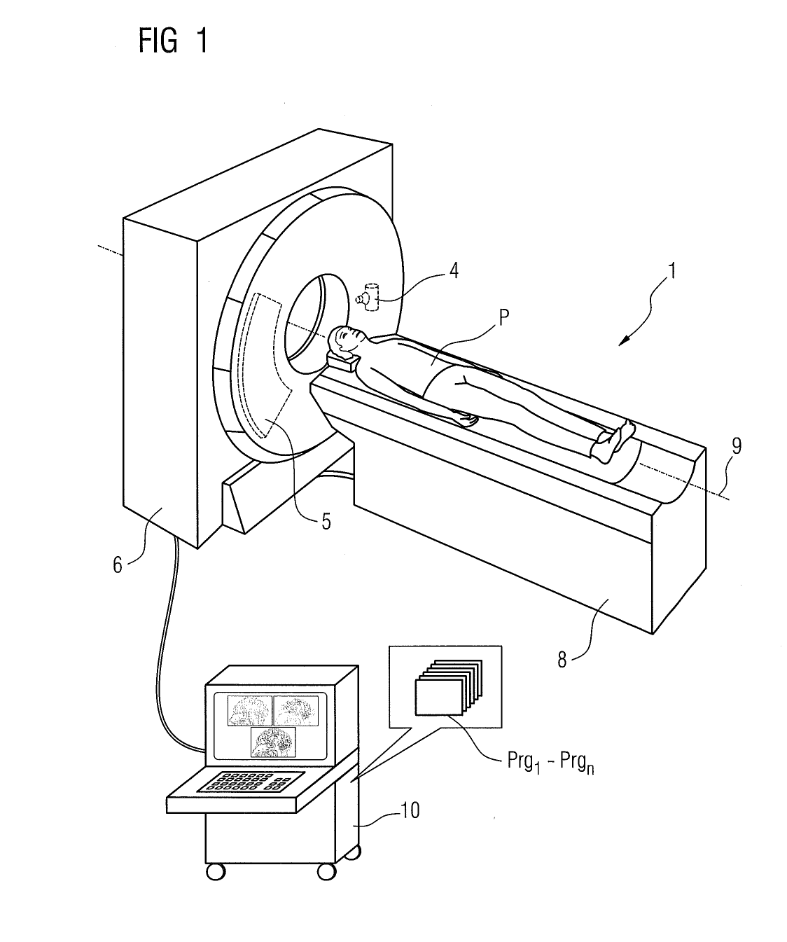

FIG. 1 shows an example CT system 1, which is able to generate both CT phase-contrast recordings and CT absorption recordings. For this, an emitter/detector system is used, which is arranged on a rotating gantry (not illustrated in detail here). The emitter is formed by an X-ray tube 4 and possibly an X-ray optical grating (=source grating) arranged on the source side. Arranged opposite thereto is a detector system 5, which is usually equipped with a detector system with an upstream phase grating and analysis grating. However, in principle reference is made to the fact that other variants of the refinement of the emitter/detector system for recording phase-contrast recordings are also possible. By way of example, the patient can be arranged not between the source grating and phase grating as illustrated here, but also between the phase grating and analysis grating, with, in this case, the small-area source grating advantageously being structured more finely than the downstream phase grating and analysis grating.

In order to measure phase-contrast CT images, a patient P, who is arranged on a displaceable patient couch 8, is then displaced along the system axis 9, while the emitter/detector system 4, 5 rotates around the patient P with the aid of the gantry. The emitter/detector system 4, 5 is arranged on a gantry and installed in a gantry housing 6. The measurement data for detecting the phase-contrast shifts of X-ray beams or the absorption data of the detector system are transmitted in a generally known fashion from this gantry housing 6 to a computational and control unit 10, which has a storage medium that stores computer programs Prg₁ to Prgₙ that during the operation of the installation reconstruct the measurement of the phase-shifts of X-ray beams known per se, including the reconstruction thereof, which X-ray beams pass through the patient, and likewise, if applicable, also reconstruct the absorption data originating from this measurement data and generate corresponding computed-tomography image data.

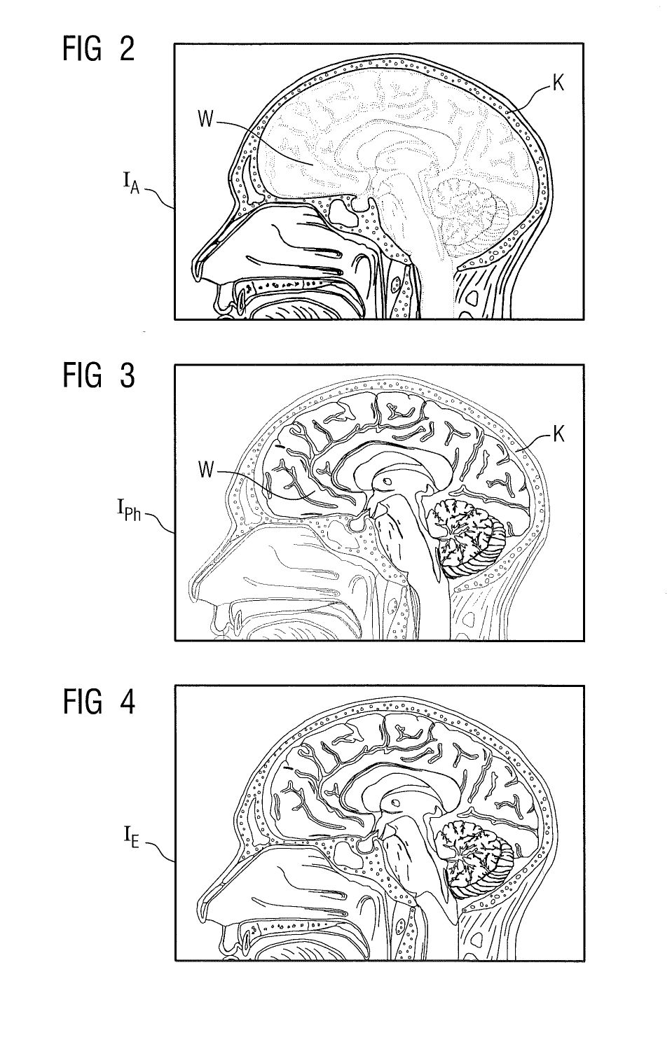

An example of such image data is shown in FIG. 2 and FIG. 3.

FIG. 2 shows a purely schematic illustration of a CT slice image I_{A}, i.e. a CT X-ray absorption recording, of a head of a patient, in which the bony structure K of the head can be identified very easily, while the soft-tissue structure W of the head, more particularly of the brain in this case, can only be identified with little richness of detail.

FIG. 3, illustrated therebelow, shows a corresponding CT recording I_{Ph}, i.e. a CT X-ray phase-contrast recording, that illustrates the bony structure K slightly less markedly, but shows a very detailed display of the soft-tissue structure W of the brain.

According to an embodiment of the invention, the respectively optimally identifiable portion is extracted from FIGS. 2 and 3 and combined in a weighted fashion to form a new image I_{E}, as shown in FIG. 4, and so a complete CT recording with optimum richness of detail is generated.

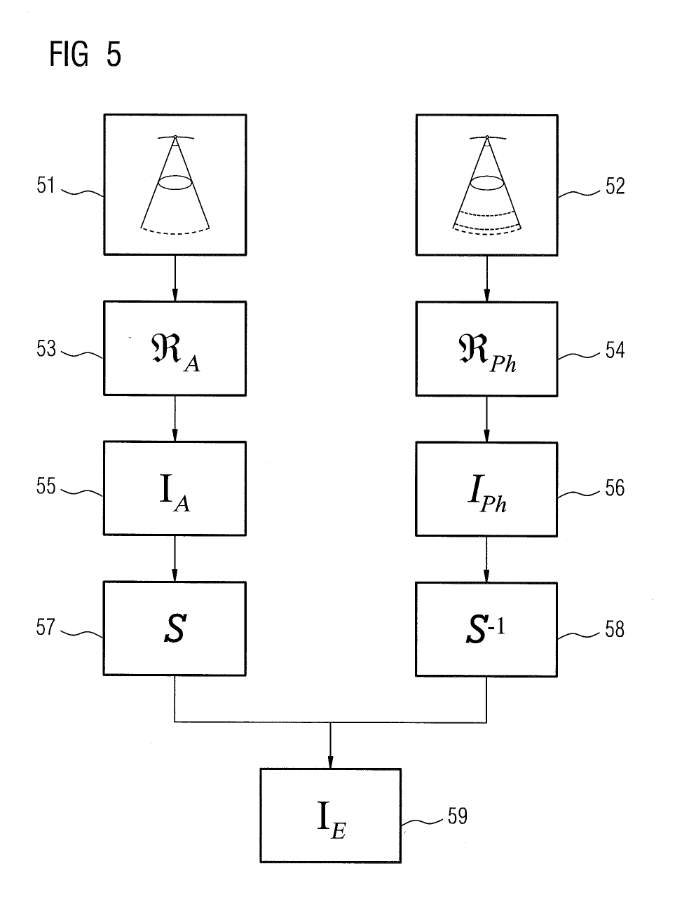

The basic principle of such a method is once again illustrated in FIG. 5 in the form of a flowchart. According to this flowchart, a CT scan is firstly carried out in respect of absorption data in method step 51 and a CT scan is carried out in respect of phase-contrast data in method step 52. It should be noted that, in the sense of this document, here it is not necessary for two mutually independent scan steps to be carried out. When scanning an examination object for measuring the phase shifts of the scanned X-ray beams, the absorption data also results as a by-product, which absorption data is necessary for an absorption CT image. However, it can also be more expedient, for example in order to obtain an improved resolution, to carry out both measurements with different emitter/detector systems specifically matched to the respective scanning type.

In method steps 53 and 54, a reconstruction of the absorption data [symbol] _{T}, and the phase-contrast data [symbol] _{Ph} is carried out, which leads to the respective image data I_{A} and I_{Ph} in method steps 55 and 56. This image data I_{A} and I_{Ph} is subsequently used to carry out a segmentation (method steps 57 and 58), wherein the segmentations S and S⁻¹ should be complementary so that no gaps are created in the image data record generated therefrom. Once the image data has been segmented, the individual segments of the image can be combined in method step 59, with the results image I_{E} being created.

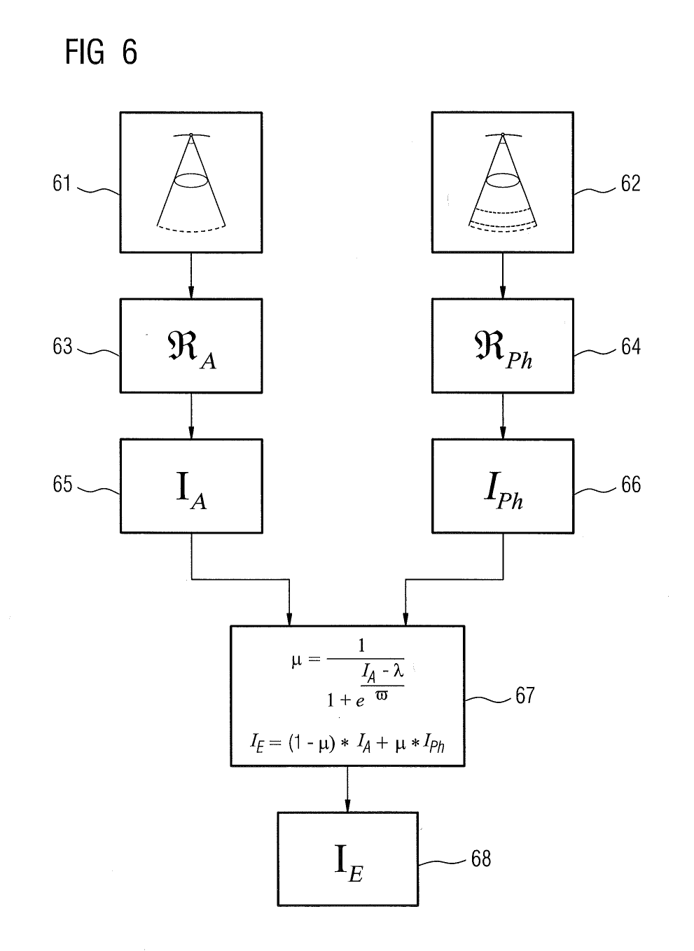

An improved variant of the method as per FIG. 5 can be achieved by a method as per FIG. 6. Herein, an absorption scan and a phase-contrast scan are carried out in turn in methods steps 61 and 62. The raw data recorded thus are converted into tomographic image data I_{A} and I_{Ph} as per method steps 65 and 66 by means of a reconstruction [symbol] _{A} and [symbol] _{Ph} in steps 63 and 64. This is followed by a weighted combination of the image data on the basis of one of the image values I_{A} or I_{Ph}, with a weighted combination as a function of the image values of the absorption image I_{A} being used in this example, and a sigmoid function being used as weighting parameter μ, which is expressed as:

$$μ = \frac{1}{1 + {e}^{\frac{{I}_{A} - λ}{ϖ}}} ,$$

and so the results image I_{E} is calculated by the equation

I_{E}=(1−μ)*I_{A}+μ*I_{Ph}.

μ corresponds to a variable bringing about a parallel displacement of the function μ, and ω̅ corresponds to a variable bringing about a stretching of the function μ. Thus, the shape of the sigmoid profile of the weighting parameter can be modified in a desired fashion by influencing these “manipulated variables”. This generates a results image I_{E}, which can be displayed accordingly in method step 68, wherein the richness of detail is significantly improved over a single absorption CT image or a single phase-contrast CT image.

Within the scope of embodiments of the invention, it is also possible for the change to be brought about online whilst the results image is being observed, and so the user can for themselves find the respectively optimum combination of manipulated variables.

It is understood that the aforementioned features of the embodiments of invention can be used not only in the respectively specified combination, but also in other combinations or on their own, without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for displaying computed-tomography examination data from an examination object, the method comprising:
reconstructing at least one first CT image data record, of the examination object with pixel or voxel values, on the basis of quantitatively measured absorption data of X-ray beams passing through the examination object;
reconstructing at least one second CT image data record, of the examination object with pixel or voxel values, on the basis of quantitatively determined phase shifts of X-ray beams passing through the examination object;
combining the at least one first CT image data record and the at least one second CT image data record together, pixel-by-pixel or voxel-by-voxel, using a nonlinear function; and
displaying the combined at least one first CT image data record and at least one second CT image data record, visually, as a CT results image data record.

2. The method as claimed in claim 1, wherein, prior to the combination, at least one of the at least one first and at least one second CT image data records is normalized to an equal range of image values.

3. The method as claimed in claim 1, wherein the nonlinearity of the function for combining the at least one first and at least one second CT image data records is at least also due to a spatial dependence of the function.

4. The method as claimed in claim 1, wherein, in one of the at least one first and at least one second CT image data records, a portion of the CT image data record is segmented according to prescribed criteria and segmented portions are combined with a different weighting than non-segmented portions.

5. The method as claimed in claim 4, wherein thresholds in respect of the CT numbers in the first CT image data record are used as criterion for the segmentation.

6. The method as claimed in claim 3, wherein bone structures are segmented.

7. The method as claimed in claim 1, wherein the nonlinearity of the function for combining the at least one first and at least one second CT image data records is at least also due to a property-dependence of the respectively observed pixels or voxels.

8. The method as claimed in claim 1, wherein the nonlinearity of the function for combining the at least one first and at least one second CT image data records is at least also due to a property-dependence of the surroundings of the respectively observed pixels or voxels.

9. The method as claimed in claim 1, wherein a sigmoid curve is used as a nonlinear function for combining the at least one first and at least one second CT image data records, the sigmoid curve determining the complementary weighting of the at least one first and at least one second CT image data records as a function of image values of at least one of the at least one first and at least one second CT image data records.

10. The method as claimed in claim 1, wherein the nonlinear function has at least one manipulated variable that is changeable by an observer and an image result is displayed directly after changing a manipulated variable, which image result is evaluateable by the observer.

11. The method as claimed in claim 1, wherein the following nonlinear function is used for combining the at least one first and at least one second CT image data records (I_{A}, I_{Ph}):
$$μ = \frac{1}{1 + {e}^{\frac{{I}_{A} - λ}{ϖ}}} ,$$
wherein I_{A} corresponds to the image value of the pixel or the voxel in the at least one first CT image data record,
λ corresponds to a variable bringing about a parallel displacement of the function μ, and
ω̅ corresponds to a variable bringing about a stretching of the function μ,
wherein the image values of the CT results image I_{E} are calculated by:
I_{E}=(1−μ)*I_{A}+μ*I_{Ph},
with I_{Ph} being the image values from the at least one second CT image data record.

12. The method as claimed in claim 1, wherein the following nonlinear function is used for combining the at least one first and at least one second CT image data records (I_{A}, I_{Ph}):
$$μ = \frac{1}{1 + {e}^{\frac{{I}_{Ph} - λ}{ϖ}}} ,$$
wherein I_{Ph} corresponds to the image value of the pixel or the voxel in the at least one second CT image data record,
λ corresponds to a variable bringing about a parallel displacement of the function μ, and
ω̅ corresponds to a variable bringing about a stretching of the function μ,
wherein the image values of the CT results image I_{E} are calculated by:
I_{E}=(1−μ)*I_{A}+μ*I_{Ph},
with I_{A} being the image values from the at least one first CT image data record.

13. A CT system for generating computed-tomography CT image data records on the basis of quantitatively measured absorption values and phase-shift values when X-ray beams pass through an examination object, the system comprising:
a control and computational unit, including a program storage medium and program code being stored in the program storage medium, to execute:
reconstructing at least one first CT image data record, of an examination object with pixel or voxel values, on the basis of quantitatively measured absorption data of X-ray beams passing through the examination object;
reconstructing at least one second CT image data record, of the examination object with pixel or voxel values, on the basis of quantitatively determined phase shifts of X-ray beams passing through the examination object; and
combining the at least one first CT image data record and the at least one second CT image data record together, pixel-by-pixel or voxel-by-voxel, using a nonlinear function, and
a display to display the combined at least one first CT image data record and at least one second CT image data record visually, as a CT results image data record.

14. A computational unit, comprising:
a program storage medium; and
a data storage medium, wherein at least one first CT image data record with pixel or voxel values is present in the data storage medium, the at least one first CT image data record being reconstructed on the basis of quantitatively measured absorption data of X-ray beams after scanning an examination object, and wherein at least one second CT image data record with pixel or voxel values is present, reconstructed on the basis of quantitatively determined phase-shifts of X-ray beams after scanning the examination object, and wherein program code is stored in the program storage medium, to execute a method as claimed in claim 1 when the computational unit is operational.

15. The method as claimed in claim 4, wherein bone structures are segmented.

16. The method as claimed in claim 5, wherein bone structures are segmented.

17. A computer readable medium including program segments for, when executed on a computer device, causing the computer device to implement the method of claim 1.
